(19) United States
(12) Patent Application Publication
(10) Pub. No.: US 2024/0255397 A1
(43) Pub. Date: Aug. 1, 2024

(54) TEST SHEET AND MEASUREMENT METHOD

(71) Applicant: SHIMADZU CORPORATION, Kyoto-shi (JP)

(72) Inventors: Kuniaki KANAMARU, Kyoto-shi (JP); Tomoki SASAYAMA, Kyoto-shi (JP)

(21) Appl. No.: 18/564,530

(22) PCT Filed: Mar. 9, 2022
(86) PCT No.: PCT/JP2022/010158

§ 371 Date: Nov. 27, 2023

(30) Foreign Application Priority Data
Jun. 22, 2021 (JP) 2021-102939

(51) Int. Cl. G01N 3/06

(52) U.S. Cl. CPC G01N 3/068; G01N 2203/0647

(57) ABSTRACT

In measuring stress or strain of a sample (1), a test sheet (90) adhered to the sample (1) is irradiated with excitation light. The test sheet (90) includes a substrate layer (92) containing a polymeric material and a stress luminescent layer (91) formed on the substrate layer (92). The stress luminescent layer (91) contains a stress luminescent material. A captured image of the test sheet (90) irradiated with the excitation light is acquired, and the luminous intensity for the test sheet is identified from the captured image.

### TECHNICAL FIELD

The present invention relates to a test sheet and a measurement method used to measure stress or strain of a target object.

### BACKGROUND ART

A technique is known in which stress or strain of a target object coated with a stress luminescent material is tested by measuring the luminance of the stress luminescent material (see, e.g., Japanese Unexamined Patent Application Publication No. 2015-75477 (Patent Document 1)).

A stress luminescent material is a material that emits light by releasing energy when the energy state is increased. The stress luminescent material emits light in response to the stress generated therein when an external mechanical force is applied. The luminous intensity correlates with the generated stress.

From the above, in the above-described test, a load is applied to the target object, the stress luminescent material coated on the target object is imaged with an imaging device, the luminous intensity of the stress luminescent material is measured from the captured image, and the stress of the stress luminescent material is identified from the measured luminous intensity.

A stress luminescent material contained in the stress luminescent material does not have adhesive ability by itself. Therefore, in order to use for the above-described test, it is necessary to mix the stress luminescent material with a base material having adhesive properties and then fixedly attach it to a sample. As a fixing method of such a stress luminescent material, for example, the stress luminescent material filled in a spray can is sprayed on a sample to paint, as described in Patent Document 1.

### PRIOR ART DOCUMENT

### Patent Document

Patent Document 1: Japanese Unexamined Patent Application Publication No. 2015-75477

### SUMMARY OF THE INVENTION

### Problems to be Solved by the Invention

In the above-described test, a technique for improving responsiveness, i.e., a technique for acquiring higher luminance intensity for the same stress, is required.

The present invention has been made in view of the above-described circumstances, and an object of the present invention is to provide a technique for improving the responsiveness in measuring stress or strain of a target object.

### Means for Solving the Problems

A test sheet according to one aspect of the present disclosure is a test sheet configured to be adhered to a target object to which a load is applied in measuring stress or strain, the test sheet comprising:
a substrate layer containing a polymeric material; and
a stress luminescent layer formed on the substrate layer, the stress luminescent layer containing a stress luminescent material,
wherein the substrate layer is thicker than the stress luminescent layer.

A test sheet according to another aspect of the present disclosure is a test sheet configured to be adhered to a target object to which a load is applied in measuring stress or strain, the test sheet comprising:
an antistatic layer;
a substrate layer formed on the antistatic layer, the substrate layer containing a polymeric material; and
a stress luminescent layer formed on the substrate layer, the stress luminescent layer containing a stress luminescent material.

A test sheet according to another aspect of the present disclosure is a test sheet configured to be adhered to a target object to which a load is applied in measuring stress or strain, the test sheet comprising:
an adhesive layer for adhering the test sheet to the target object;
a substrate layer formed on the antistatic layer, the substrate layer containing a polymeric material; and
a stress luminescent layer formed on the substrate layer, the stress luminescent layer containing a stress luminescent material.

A measurement method according to another aspect of the present disclosure is a method of measuring stress or strain of a target object, the method comprising:
a step of irradiating one or more test sheets adhered to the target object with excitation light, each of the one or more test sheets comprising a substrate layer containing a polymeric material, and a stress luminescent layer formed on the substrate layer, the stress luminescent layer containing a stress luminescent material;
a step of acquiring a captured image of each of the one or more test sheets irradiated with the excitation light; and
a step of identifying luminous intensity for the one or more test sheets from each of the captured images of the one or more test sheets.

### Effects of the Invention

According to a certain aspect of the present disclosure, the substrate layer is thicker than the stress luminescent layer, and therefore, the responsiveness of the luminescence to the stress of the stress luminescent layer can be enhanced.

According to other aspects of the present disclosure, an antistatic layer is positioned between the substrate layer and the target object, and therefore, the responsiveness of the luminescence to the stress of the stress luminescent layer can be enhanced.

According to still other aspects of the present disclosure, it becomes no longer necessary to separately prepare an adhesive when adhering a test sheet to a target object.

According to another aspect of the present disclosure, a test sheet having a stress luminescent layer with enhanced responsiveness of the luminescence to stress is utilized, and therefore, the stress of the target object can be measured more accurately.

### BRIEF DESCRIPTION OF THE DRAWINGS

FIG. 1 is a diagram showing a configuration example of a measuring device 100 utilized in this embodiment.

FIG. 2 is a diagram showing one example of a configuration of the test sheet 90.

FIG. 3 is a diagram showing one example of the measurement result of the luminous intensity when SUS304 was used as the material for the sample 1.

FIG. 4 is a diagram showing one example of the measurement result of the luminous intensity when A1050 was used as the material for the sample 1.

FIG. 5 is a diagram showing one example of the measurement result of the luminous intensity when A6061 was used as the material for the sample 1.

FIG. 6 is a diagram showing one example of the measurement result of the luminous intensity when SUS430 was used as the material for the sample 1.

FIG. 7 is a flowchart of the processing (measurement steps) performed in the measuring device 100 to measure the stress or strain of the sample 1.

FIG. 8 is a diagram schematically showing a scene in which test sheets are affixed at a plurality of locations on a sample in measurement.

FIG. 9 is a diagram showing one example of the steps for preparing three test sheets 90X, 90Y, and 90Z shown in FIG. 8.

FIG. 10 is a diagram showing one example of the result of a stress analysis using an FEM.

### EMBODIMENTS FOR CARRYING OUT THE INVENTION

Hereinafter, some embodiments of the present disclosure will be described with reference to the attached drawings. Note that the same or equivalent part in the figures is assigned by the same reference symbol, and the description will not be repeated. In addition, with respect to the embodiments of the present disclosure, numerical values of the amount, temperature, and concentration of reagents and other substances are disclosed, which shall include not only the disclosed values but also the vicinity of the disclosed values.

### <Measuring Device>

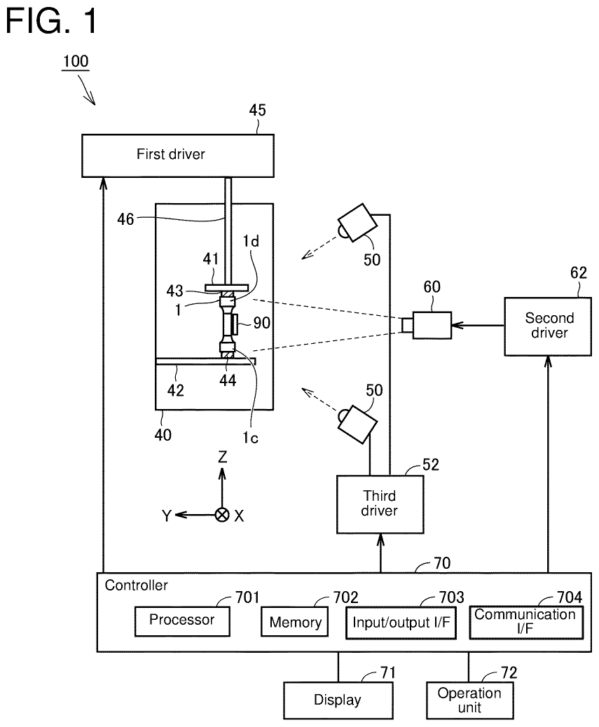

FIG. 1 is a diagram showing a configuration example of a measuring device 100 utilized in this embodiment. In the example shown in FIG. 1, a test sheet 90 containing a stress luminescent material is adhered to the sample 1, and the measuring device 100 measures the luminescence of the stress luminescent material when a tensile load is applied to the sample 1. The sample 1 is one example of the “target object” which is a measurement target of stress or strain. Note that the example shown in FIG. 1 is one example of stress or strain measurement with respect to the sample 1. The stress or strain measurement method is not limited to the method by means of the measuring device 100 shown in FIG. 1.

The measuring device 100 is provided with a holder 40, light sources 50, a camera 60, a first driver 45, a second driver 62, a third driver 52, and a controller 70.

The holder 40 is configured to support the sample 1 by contacting at least two points of the sample 1. In the example shown in FIG. 1, the holder 40 is configured to support two mutually opposed end portions of the sample 1 (the first end portion 1c and the second end portion 1d). Specifically, the holder 40 has a fixed wall 42, a movable wall 41, and connection members 43, 44. In FIG. 1, in the state in which the holder 40 is placed, the width direction is defined as an X-axis direction, the depth direction is defined as a Y-axis direction, and the height direction is defined as a Z-axis direction.

The fixed wall 42 and the movable wall 41 are installed so as to face each other in the X-axis direction. The fixed wall 42 is fixed to the bottom of the holder 40. On the other hand, the movable wall 41 is configured to be movable in the Z-axis direction (in the up-and-down direction in the paper) by receiving an external force from the first driver 45.

The first end portion 1c of the sample 1 is connected to the fixed wall 42 by a connection member 44. The second end portion 1d of the sample 1 is connected to the movable wall 41 by a connection member 43. In the measuring device 100, a tensile load is applied to the sample 1 by increasing the distance in the Z-axis direction between the fixed wall 42 and the movable wall 41. The first driver 45 is connected to the holder 40 and configured to change the relative position of the first end portion 1c and the second end portion 1d by moving the movable wall 41.

On the sample 1, a test sheet 90 is adhered to the surface of the sample facing the camera 60. The light source 50 is positioned above the sample 1 in the Z-axis direction and is configured to irradiate the test sheet 90 with excitation light.

Upon receiving the excitation light, the stress luminescent material of the test sheet 90 transitions to a luminescent state. The excitation light is, for example, ultraviolet or near-infrared. Although FIG. 1 illustrates a configuration in which excitation light is emitted to the sample 1 (test sheet 90) from two directions, the light source 50 may be configured to irradiate the sample 1 (test sheet 90) with excitation light from one direction or three or more directions.

The third driver 52 supplies power to drive the light sources 50. The third driver 52 controls the power supplied to the light sources 50 in response to the commands received from the controller 70, thereby controlling conditions, such as the intensity of the excitation light emitted from the light source 50 and the duration of the excitation light.

The camera 60 is positioned above the sample 1 in the Z-axis direction so as to include at least a part of the test sheet 90 on the sample 1 in the imaging field of view. Specifically, the camera 60 is arranged so that the focus position is positioned at at least one point on the test sheet 90 on the sample 1.

The camera 60 includes optics, such as a lens, and an image sensor element. The image sensor element is realized by, for example, a CCD (Charge Coupled Device) sensor, a CMOS (Complementary Metal Oxide Semiconductor) sensor, or the like. The image sensor element produces a captured image by converting the light incident from the imaging target through the optics into an electrical signal. The data (image data) of the captured image is transmitted to the controller 70.

The second driver 62 changes the focus position of the camera 60 in response to the command received from the controller 70. The second driver 62 may adjust the focus position of the camera 60 by moving the camera 60 along the Z-axis direction. In one implementation example, the second driver 62 has a motor for rotating a feed screw that moves the camera 60 in the Z-axis direction and a motor driver for driving the motor. The feed screw is rotatably driven by the motor to position the camera 60 at a position specified within a predetermined range in the Z-axis direction. Further, the second driver 62 transmits the position information indicating the position of the camera 60 to the controller 70.

The controller 70 controls the entire measuring device 100. The controller 70 has, as main components, a processor 701, a memory 702, an input/output interface (I/F) 703, and a communication I/F 704. These parts are communicatively connected to each other via a bus which is not illustrated.

The processor 701 may be realized by one or more arithmetic processing units, such as a Central Processing Unit (CPU) and a Micro Processing Unit (MPU). The processor 701 reads and executes the program stored in the memory 702 to control the operation of each part of the measuring device 100. Specifically, the processor 701 executes the program to realize each processing of the measuring device 100 which will be described below.

The memory 702 is realized by a non-volatile memory, such as a RAM (Random Access Memory), a ROM (Read Only Memory), and a flash memory. The memory 702 stores programs executed by the processor 701, data used by the processor 701, or the like.

The input/output interface 703 is an interface for the processor 701 to exchange various data with the first driver 45, the third driver 52, the camera 60, and the second driver 62.

The communication I/F 704 is a communication interface for exchanging various data between the measuring device 100 and other devices, and is realized by an adapter, a connector, or the like. Note that the communication method may be a wireless communication method using a wireless LAN (Local Area Network) or a wired communication method using a USB (Universal Serial Bus) or the like.

Connected to the controller 70 are a display 71 and an operation unit 72. The display 71 is configured by a liquid crystal panel or the like capable of displaying an image. The operation unit 72 receives the user's operational input to the measuring device 100. The operation unit 72 is typically configured by a touch panel, a keyboard, a mouse, or the like.

The controller 70 is communicatively connected to the first driver 45, the third driver 52, the camera 60, and the second driver 62. The communication between the controller 70 and the first driver 45, the third driver 52, the camera 60, and the second driver 62 may be realized by wireless communication or by wired communication.

### <Test Sheet>

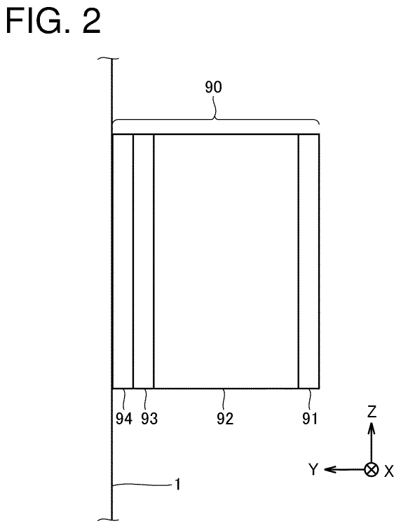

FIG. 2 is a diagram showing one example of the configuration of a test sheet 90. In the example shown in FIG. 2, the test sheet 90 includes an adhesive layer 94, an antistatic layer 93 formed on the adhesive layer 94, a substrate layer 92 formed on the antistatic layer 93, and a stress luminescent layer 91 formed on the substrate layer 92. The test sheet 90 is adhered to the sample 1 by the adhesive layer 94. The test sheet 90 is produced by, for example, screen printing a stress luminescent layer 91 on the surface of a polyester-based film in a surface protective material for optical films (E-MASK_RP301 manufactured by Nitto Denko Corporation).

In FIG. 2, the same three axes (X-axis, Y-axis, and Z-axis) are shown as in FIG. 1. In the example shown in FIG. 2, the adhesive layer 94, the antistatic layer 93, the substrate layer 92, and the stress luminescent layer 91 have the same dimensions in the XZ-axis plane and are overlapped in the Y-axis direction so that they are in close contact with each other.

Note that in this specification, the description “second layer formed on the first layer” may be interpreted broadly as the positional relation between the first layer and the second layer. That is, the description can include that the first layer and the second layer are arranged so that at least the portions thereof overlap each other in the Z-axis direction. Further, the description can include that other substances are arranged at least partially between the first layer and the second layer. Furthermore, the description may include a third layer placed between the first layer and the second layer. In other words, the example shown in FIG. 2 may be interpreted such that the substrate layer 92 is formed on the adhesive layer 94.

### (1) Adhesive Layer

The adhesive layer 94 may be configured by any materials for adhering the test sheet 90 to the sample 1. In a case where the adhesive layer 94 is made of a removable adhesive, the test sheet 90 can be peeled off from the sample 1 without leaving residues after it is adhered to the sample 1 in the test. This not only prevents residues from remaining on the sample 1 after the test but also allows the attachment position of the test sheet 90 to be changed during the test without leaving residues on the sample 1 during the test. The removable adhesive may be, for example, but not limited thereto, an adhesive made of polyurethane.

Since the test sheet 90 includes the adhesive layer 94, it becomes no longer necessary to separately prepare an adhesive to make the test sheet 90 adhere to the sample 1. However, it is not essential that the test sheet 90 include the adhesive layer 94. In a case where the test sheet 90 does not include the adhesive layer 94, the test sheet 90 can be adhered to the sample 1 by means of a separately prepared adhesive.

### (2) Antistatic Layer

The antistatic layer 93 is positioned for the antistatic purpose in the test sheet 90 and can also be made of a material commonly utilized as an antistatic agent.

Since the test sheet 90 includes the antistatic layer 93, the charging of the substrate layer 92 is suppressed. With this, the luminous intensity of the stress luminescent layer 91 can be enhanced when the same stress is applied. However, it is not essential that the test sheet 90 include the antistatic layer 93. In other words, the test sheet 90 may be adhered to the sample 1 by adhering the substrate layer 92 to the sample. Further, in some cases, the test sheet 90 may be configured such that the adhesive layer 94 is in close contact with the substrate layer 92.

### (3) Substrate Layer

The substrate layer 92 is made of various polymeric materials (PEN (polyethylene naphthalate), PET (polyethylene terephthalate), polyester, etc.). It is preferable that the substrate layer 92 be thicker than the stress luminescent layer 91. The thickness of the substrate layer 92 is, for example, preferably 10 μm to 70 μm, more preferably 30 μm to 60 μm. In this specification, the “thickness” refers to the dimension in the direction perpendicular to the surface of the sample.

### (4) Stress Luminescent Layer

The stress luminescent layer 91 contains a stress luminescent material. The thickness of the stress luminescent layer 91 is preferably 10 μm or less, more preferably 3 μm to 7 μm, since the luminescence reflects the stress of the sample 1 rather than the stress of the stress luminescent layer 91 itself.

The stress luminescent material is a material in which an element serving as the luminescent center is solidly dissolved in the framework of an inorganic crystal (base material), and the typical example thereof is strontium aluminate doped with europium. Other examples include zinc sulfide doped with transition metals or rare earths, barium calcium titanate, and calcium yttrium aluminate. In this embodiment, as the stress luminescent material, any known stress luminescent material can be used.

The stress luminescent material is, for example, a matrix material of a substance selected from the group consisting of strontium aluminate, zinc sulfide, strontium tin oxide, and lithium niobate. The matrix material is activated with ions of at least one element selected from the group consisting of Eu, Nd, Zr, Ho, Sc, Y, La, Ce, Pr, Pm, Sm, Er, Dy, Gd, Tm, Yb, Lu, and Tb.

In one implementation example, the stress luminescent layer 91 is made by printing the stress luminescent material on the surface of the substrate layer 92. In one implementation example, for printing, a material is first prepared by dispersing solid particles of pigments (stress luminescent material) in a mixture of an adhesive matrix called a vehicle and a solvent.

More specifically, the material is squeezed on a screen, such as a mesh, to fill the screen voids with the material to temporarily form a kind of sticker. Then, the material is again squeezed on a printing material through the screen, so that the above sticker is transferred to the printing material. In this method, since the paint filled on the screen of a specified thickness is transferred, uniform film thickness formation can be easily achieved, and the film thickness of the printed material can be controlled by changing the thickness of the screen.

In forming the stress luminescent layer 91, the stress luminescent material (solid particles) may be fine-grained to a submicron-order particle size. The stress luminescent material can be pulverized using any known pulverizing device, and the type is not limited to a particular one. However, there is a possibility that the stress luminescence material is low in water resistance and is altered by heating, resulting in a decrease in stress luminescence intensity. For this reason, it is preferable to use a pulverizing device that can pulverize particles to a submicron order by colliding them with each other at high speed.

For example, a wet-type fine grinding machine (Device name: LaboStar, manufactured by Ashizawa Finetech Co.) can be used. In this wet-type fine grinding machine, a rotor is rotated in a chamber accommodating bead-shaped grinding media, and the slurry sample is circulated in the chamber to collide with the media, thereby pulverizing the sample.

Alternatively, a fine pulverizer (Device name: NanoJetMizer, manufactured by Aisin Nanotechnologies, Inc.) can be used. This fine pulverizer accelerates particles by forming a concentric swirling vortex with a high-pressure jet stream inside the mill. The particles can be pulverized to the nano-level by the collision between the accelerated particles. In this case, the Joule-Thomson effect (temperature lowering effect during atmospheric pressure free expansion) can suppress the temperature rise of the crushed material.

Note that the conditions of the pulverization are not specifically limited and may be set by considering the particle size and the particle size distribution of the stress luminescent material prior to the pulverization.

The solvent contains a film-forming resin. As the film-forming resin, a thermosetting resin, a room temperature curing resin, an ultraviolet curing resin, a radiation effect resin, etc., can be used. Examples include an epoxy resin, an acrylic resin, an alkyd resin, a urethane resin, a polyester resin, an amino resin, an organosilicate, and an organotinamate. For the solvent, a solvent that can transmit at least the excitation light used to excite the stress luminescent material and the fluorescence emitted from the stress luminescent material is used.

The solvent may contain a paint additive, such as a solvent, a dispersant, a filler, a thickener, a leveling agent, a curing agent, a pigment, a defoaming agent, an antioxidant, a light stabilizer including a UV absorber, a flame retardant, a catalyst for curing, a germicide and an antibacterial agent, as needed.

In one implementation example, the stress luminescent material is crushed in a slurry state in which the stress luminescent material is dispersed in a solvent, thereby mixing the stress luminescent material with the solvent. The crushing method is not specifically limited, but for example, a method using a roller mill, a ball mill, or the like, may be employed.

The content of the stress luminescent material in the stress luminescent layer 91 may be adjusted as appropriate to the extent that it does not interfere with the flexibility required for the stress luminescent material. For example, the stress luminescent material may be 150 PHR (150 parts of the stress luminescent material to 100 parts of the solvent, i.e., 60 wt %) to the solvent which is mainly composed of a film-forming resin.

The blending ratio of the stress luminescent material in the stress luminescent layer 91 is preferably 20 wt % or more, more preferably 40 wt % or more, and even more preferably 50 wt % or more. This is because when the blending ratio of the stress luminescent material is less than 20 wt %, the particle spacing of the stress luminescent material in the stress luminescent layer 91 becomes large, and there is a concern that the stress applied to the stress luminescent layer 91 will escape into the solvent, thereby reducing the stress luminescence capacity.

### <Correspondence to Changes in Sample Material>

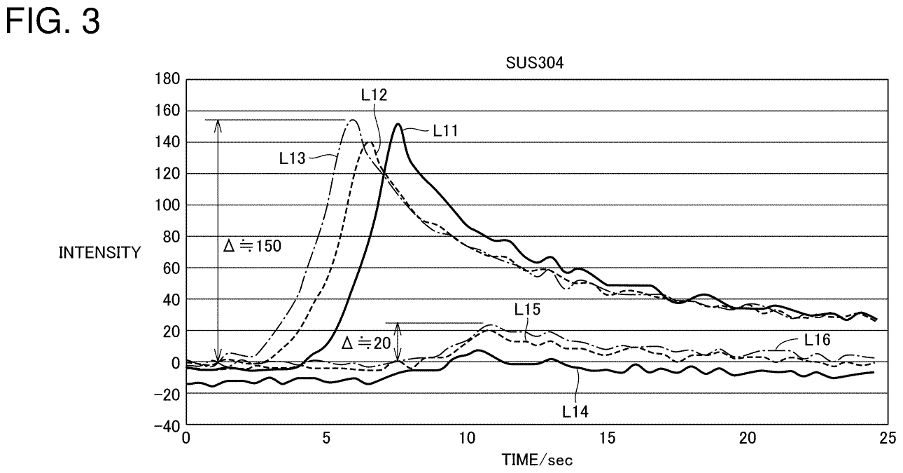

The test sheet 90 of this embodiment has better responsiveness to a plurality of types of material samples than in a case where the stress luminescent layer is formed directly on the sample. This will be explained below with reference to FIG. 3 to FIG. 6.

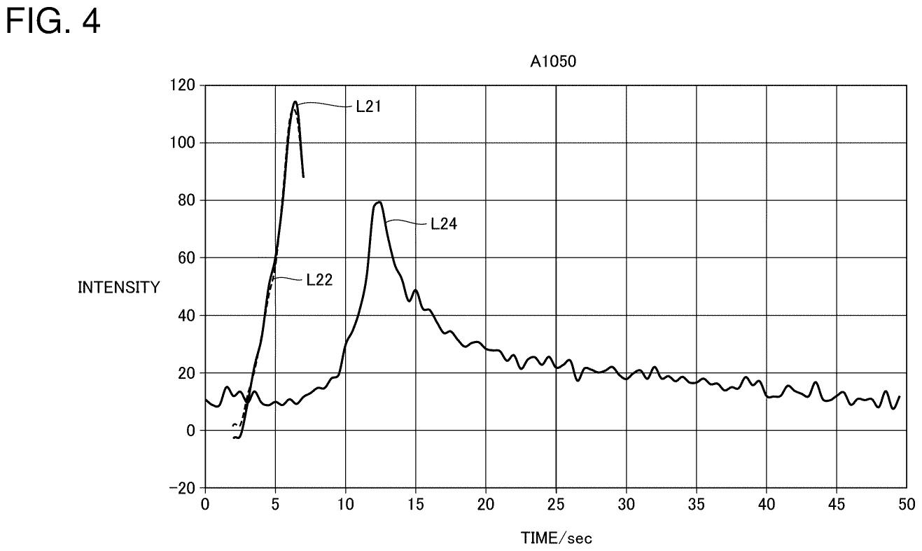

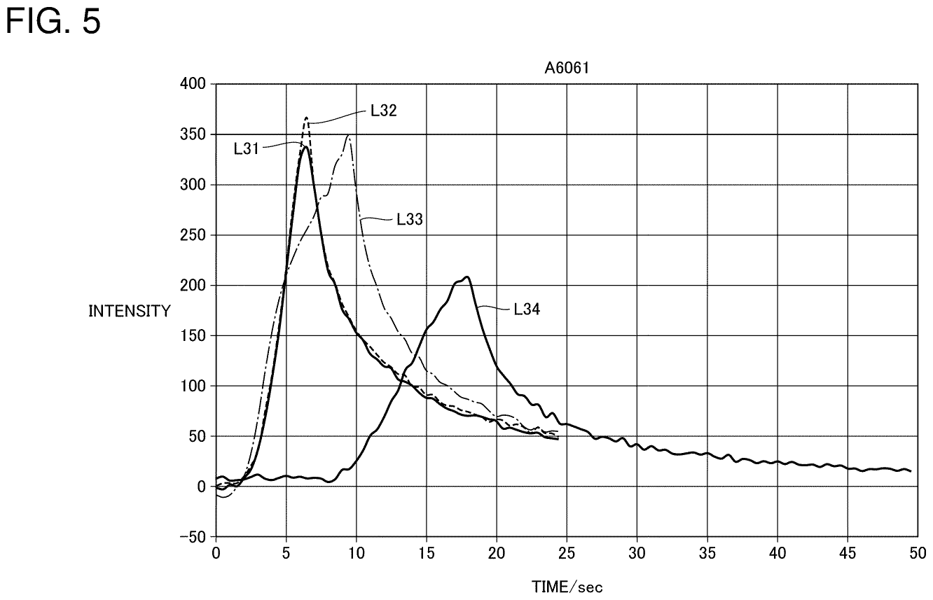

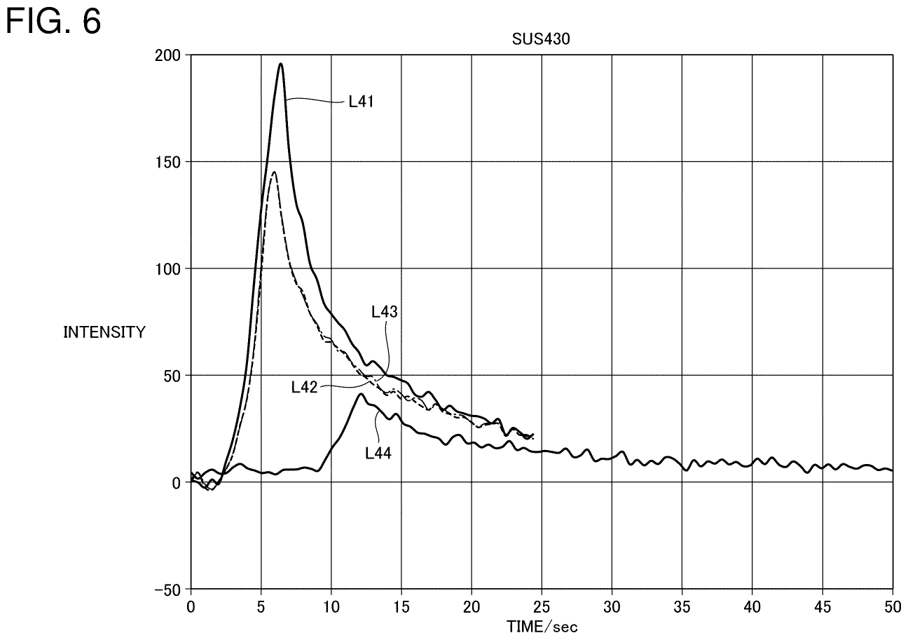

FIG. 3 to FIG. 6 show the measurement results of the luminous intensity for each of the four materials (SUS304, A1050, A6061, and SUS430) according to JIS standards. More specifically, FIG. 3 is a diagram showing one example of the measurement results of the luminous intensity when SUS304 was used as the material of the sample 1. FIG. 4 is a diagram showing one example of the measurement results of the luminous intensity when A1050 was used as the material of the sample 1. FIG. 5 is a diagram showing one example of the measurement results of the luminous intensity when A6061 was used as the material of the sample 1. FIG. 6 is a diagram showing one example of the measurement results of the luminous intensity when SUS430 was used as the material for the sample 1.

### (1) FIG. 3

In FIG. 3, each of the lines L11-L13 represents the measured result of the luminous intensity of the test sheet 90 according to this embodiment. In FIG. 3, each of the lines L14-L16 represents comparative examples. The vertical axis represents the detected luminous intensity, and the horizontal axis represents “time.”

More specifically, the lines L11-L13 were measured in a state in which the test sheet 90 including the stress luminescent layer 91 and the substrate layer 92 is fixed to the sample 1. The lines L11-L13 represent the results of three measurements performed on the same test sheet 90.

As the test sheet 90, a striped sheet of 80.0 mm×12.5 mm was prepared. The stripped sheet was cut out from a film including the stress luminescent layer 91 and the substrate layer 92. The test sheet 90 included a PEN film with a thickness of 100 μm as the substrate layer 92. Further, the test sheet 90 had, as the stress luminescent layer 91, a stress luminescent film with a thickness of 5 μm. The stress luminescent film contained, as the stress luminescent material, fine particles obtained by applying additional pulverization processing to ML-032 produced by Sakaikagaku Kogyo Co. The substrate layer 92 of the test sheet 90 was adhered to the sample 1 with an instant adhesive (CC-33A produced by Kyowa Dengyo Co.). With this, the test sheet 90 was adhered to one side of the sample 1.

The lines L14-L16 were measured for the stress luminescent layer formed directly on the surface opposite the surface to which the test sheet 90 was adhered in the sample 1. The lines L14-L16 represent the results of three measurements performed on the same stress luminescent layer.

The stress luminescent layer, which is a comparative example, was formed by screen printing. The thickness of the stress luminescent layer was 5 μm.

Each of the lines L11-L13 and L14-L16 represents the result when the tensile strength was increased to a maximum of 1.6 kN at 5 mm/min for the sample 1. The sample 1 was a test piece of SUS304 (JIS Z2241 Tensile Test Method for Metallic Materials, No. 13B test piece, 0.5 mm thick).

The measurement result shown by the line L13 includes the luminous intensity of up to about 150 units. Further, the measurement results shown by the lines L11 and L12 also include the maximum luminous intensity of about the same degree as the line L13.

On the other hand, the measurement result shown by the line L16 includes the luminous intensity of up to about 20 units. Further, the measurement results shown by the lines L14 and L15 include the maximum luminous intensity of about the same degree as the line L16.

That is, it can be said that the measurement results shown by the lines L11-L13 have a maximum luminous intensity about seven times greater than the measurement results shown by the lines L14-L16. Therefore, it can be said that the stress luminescent layer according to this embodiment shown by the lines L11-L13 is more responsive to luminescence than the stress luminescent layer of comparative examples shown by the lines L14-L16.

### (2) FIG. 4

In FIG. 4, each of the lines L21 and L22 represents the measurement result of the luminous intensity of the test sheet 90 according to this embodiment. In FIG. 4, the line L24 represents a comparative example. In contrast to the measurement results in FIG. 3, the measurement results in FIG. 4 were obtained under the same conditions except that an A1050 test piece (JIS Z2241 Tensile Test Method for Metallic Materials No. 13B test piece, 1.0 mm thick) was used as the sample 1 and the maximum tensile strength was 1.4 kN.

The measurement result shown by the line L21 includes the luminous intensity of up to about 110 units. Further, the measurement result shown by the lines L22 also includes the maximum luminous intensity of about the same degree as the line L21.

On the other hand, the measurement result shown by the line L24 includes the luminous intensity of up to about 80 units. That is, it can be said that the measurement results shown by the lines L21-L22 have a maximum luminous intensity about 1.5 times greater than the measurement results shown by the line L24. Therefore, it can be said that the stress luminescent layer according to this embodiment shown by the lines L21-L22 is more responsive to luminescence than the stress luminescent layer of the comparative example shown by the line L24.

### (3) FIG. 5

In FIG. 5, each of the lines L31 to L33 represents the measurement result of the luminous intensity of the test sheet 90 according to this embodiment. In FIG. 5, the line L34 represents a comparative example. In contrast to the measurement results in FIG. 3, the measurement results in FIG. 5 were obtained under the same conditions except that a test piece of A6061 (JIS Z2241, Tensile Test Method for Metallic Materials No. 13B test piece, 1.0 mm thick) was used as a sample 1, and the maximum tensile strength values were changed. Note that in the example in FIG. 5, a maximum tensile strength of up to 1.6 kN was applied for the lines L31-L33. For the line L34, a maximum tensile strength of 3.5 kN was applied.

The measurement result shown by the line L33 includes the luminous intensity of up to about 350 units. Further, the measurement results shown by the lines L31 and L32 also include the maximum luminous intensity of about the same degree as the line L33.

On the other hand, the measurement result shown by the line L34 includes the luminous intensity of up to about 200 units. That is, it can be said that the measurement results shown by the lines L31-L33 have the maximum luminous intensity about 1.75 times greater than the measurement results shown by the line L34. Therefore, it can be said that the stress luminescent layer according to this embodiment shown by the lines L31-L33 is more responsive to luminescence than the stress luminescent layer of the comparative example shown by the line L34.

### (4) FIG. 6

In FIG. 6, each of the lines L31-L33 represents the measurement result of the luminous intensity of the test sheet 90 according to this embodiment. In FIG. 6, the line L34 represents a comparative example. In contrast to the measurement results in FIG. 3, the measurement results in FIG. 6 were obtained under the same condip piece of SUS430 (JIS Z2241, Tensile Test Method for Metallic Materials No. 13B test piece, 0.5 mm thick) was used as a sample 1, and the maximum tensile strength values were changed. Note that in the example shown in FIG. 6, a maximum tensile strength of 1.6 kN was applied for the lines L41-L43. For the line L34, a maximum tensile strength of 1.65 kN was applied.

The measurement result shown by the line L43 includes the luminous intensity of up to about 140 units. Further, the measurement result shown by the line L42 also includes the maximum luminous intensity of about the same degree as the line L43. The measurement result indicated by line L41 has the maximum luminous intensity (about 190 units) greater than those indicated by the lines L42 and L43.

On the other hand, the measurement result shown by the line L44 includes the luminous intensity of up to about 40 units. That is, it can be said that the measurement results shown by the lines L42 and L43 have the maximum luminous intensity about 3.5 times greater than the measurement results shown by the line L44. Further, it can be said that the measurement result shown by the line L41 has the maximum luminous intensity about 4.75 times greater than the measurement result shown by the line L44. Therefore, it can be said that the stress luminescent layers according to this embodiment shown by the lines L41-L43 are more responsive to luminescence than the stress luminescent layer of the comparative example shown by the line L44.

### (5) Summary of FIG. 3 to FIG. 6

As explained with reference to FIG. to FIG. 6, it can be said that the test sheet 90 according to this embodiment is more responsive to luminescence than the case where the stress luminescent layer was formed on the sample 1, which is shown as a comparative example. Note that the fact that the test sheet 90 of this embodiment is highly responsive to a comparative example is not limited to the types of samples described with reference to FIG. 3 to FIG. 6.

### <Measurement Processing>

### (1) Processing Flow

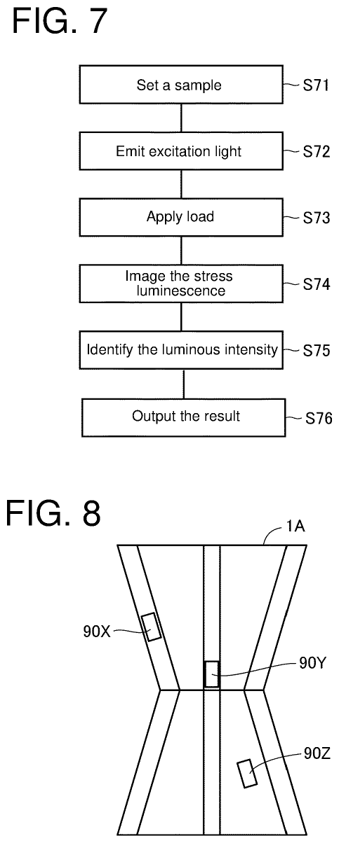

FIG. 7 is a flowchart of the processing (measurement steps) performed in the measuring device 100 to measure the stress or strain of the sample 1. As shown in FIG. 7, the measurement processing (S70) mainly includes a step of setting a sample (S71), a step of irradiating it with excitation light (S72), a step of applying a load (S73), a step of imaging the stress luminescence (S74), a step of identifying the luminous intensity (S75), and a step of outputting the result (S76).

First, a step of setting the sample (S71) is performed. In this step (S71), a sample 1 is set in the holder 40. The sample 1 is set so that the surface to which the test sheet 90 is adhered faces the light source 50 and the camera 60.

Next, the step of irradiating excitation light (S72) is performed. In this step (S72), the controller 70 emits excitation light from the light source 50 to the test sheet 90 adhered to the sample 1. With this, the stress luminescent material in the stress luminescent layer 91 of the test sheet 90 transitions to an excited state.

The user may set the sample 1 and operate a given switch in S71. The controller 70 may execute S72 in response to the operation of the above given switch.

Next, the step of applying a load (S73) is performed. In this step (S73), the controller 70 drives the actuator 46 provided to the first driver 45 to move the movable wall 41 of the holder 40 to apply a tensile load to the sample 1.

Next, the step of imaging the stress luminescence (S74) is performed. In this step (S74), the controller 70 causes the camera 60 to capture the image of the test sheet 90 on the sample 1.

In the step (S74), the controller 70 may control at least one of the first driver 45 and the second driver 62 so that the focus position of the camera 60 is maintained at at least one point on the test sheet 90 on the sample 1. As one embodiment of such a control, the controller 70 may control the second driver 62 to maintain the focus position of the camera 60 at at least one point on the test sheet 90. Specifically, the second driver 62 may be configured to maintain the focus position of the camera 60 at at least one point on the test sheet 90 by moving the camera 60 in response to the movement of the predetermined region of the sample 1 in accordance with the command received from the controller 70.

Next, the step of identifying the luminous intensity (S75) is performed. In this step (S75), the controller 70 identifies the distribution of the luminous intensity on the test sheet 90 of the sample 1 by applying known image processing to the image data from the image captured by the camera 60. In one example, the distribution of the maximum luminous intensity measured when a tensile load is applied is identified for each portion of the test sheet 90.

Next, the step of outputting the results (S76) is performed. In the step (S76), the controller 70 outputs the distribution of the luminous intensity identified in the step S75 to other devices as a measurement result. In one implementation example, the controller 70 outputs the distribution toward the display 71. With this, the user can visually confirm the distribution of the luminous intensity displayed on the display 71.

### (2) Measurement for a Plurality of Locations

FIG. 8 is a diagram schematically showing a scene in which test sheets are adhered to a plurality of locations on a sample in measurement. In the example shown in FIG. 8, the sample 1A has a three-dimensional structure on its surface. In the example in FIG. 8, test sheets (test sheets 90X, 90Y, and 90Z) are attached to three locations on the surface of the sample 1A.

The measuring device 100 can emit excitation light to each of the test sheets 90X, 90Y, and 90Z, image them, and output the distribution of the light luminous intensity.

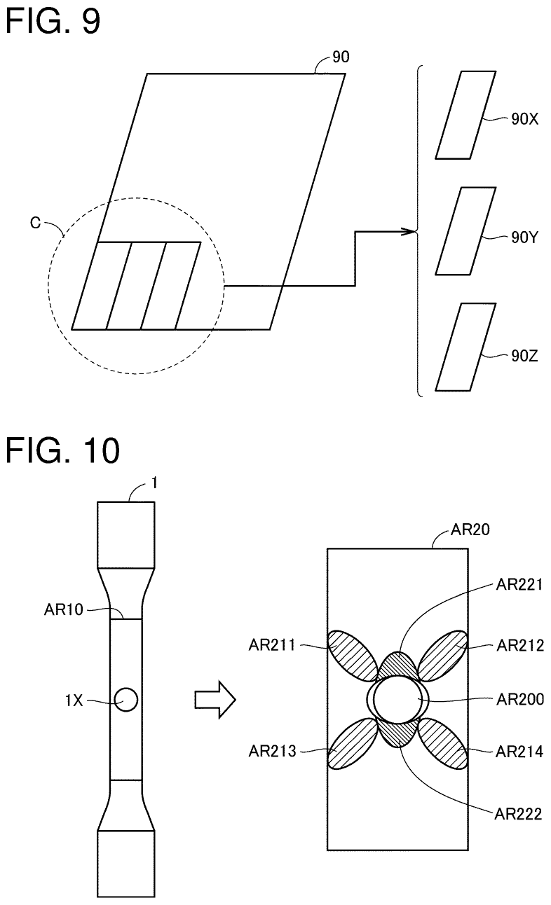

FIG. 9 is a diagram showing one example of the step of preparing the three test sheets 90X, 90Y, and 90Z shown in FIG. 8. In FIG. 9, three test sheets 90X, 90Y, and 90Z are cut out from one sheet 90A. In other words, in the example in FIG. 9, cut pieces from a single sheet 90A are utilized as the plurality of test sheets 90X, 90Y, 90Z configured to be adhered to each of the plurality of locations of the single sample 1A in FIG. 8. In the plurality of test sheets 90X, 90Y, 90Z cut out from a single sheet, their optical properties are likely to be uniform. Thus, in the example shown in FIG. 9, measurements for each of the plurality of locations of a single sample 1A will be performed using the plurality of test sheets 90X, 90Y, 90Z with uniform optical properties.

Note that a method such as an FEM (Finite Element Method) may be used to predict the position of attaching the test sheets 90X, 90Y, 90Z to the sample 1A.

FIG. 10 is a diagram showing one example of the result of a stress analysis using an FEM. In FIG. 10, the sample 1 is shown on the left and the portion of the sample 1 is shown as a region AR10. In FIG. 10, the result of the FEM stress analysis for the region AR10 is shown on the right side as an image AR20. Note that a hole 1X is formed in the region AR10. The image AR20 includes a circle AR200 corresponding to the hole 1X.

The image AR20 shows the magnitude of stress expected to occur for each portion of the region AR10 by the type of hatching. In the example shown in FIG. 10, the image AR20 includes different types of hatching in the four regions AR211-AR214 and the two regions AR221. With this, in the four regions AR211-AR214 and the two regions AR221, it indicates that stresses different in magnitude occur.

The user may perform a FEM analysis on the sample before attempting to perform measurement on stress or strain using the measuring device 100 on a sample. The user may use the FEM analysis to determine which location of the sample is to be measured, i.e., which location of the sample is adhered by the test sheet.

In one implementation example, the user may perform the measurement by adhering a test sheet to the location where the greater stress is predicted to occur. In other implementation examples, the user may adhere a test sheet to each of several locations where the magnitude of the stresses predicted to occur is the same (or close) to each other.

### [Aspects]

It would be understood by those skilled in the art that the plurality of exemplary embodiments described above is specific examples of the following aspects.

### (Item 1)

A test sheet according to one aspect of the present disclosure is a test sheet configured to be adhered to a target object to which a load is applied in measuring stress or strain, the test sheet comprising:
a substrate layer containing a polymeric material; and
a stress luminescent layer formed on the substrate layer, the stress luminescent layer containing a stress luminescent material,
wherein the substrate layer is thicker than the stress luminescent layer.

According to the test sheet as recited in the above-described Item 1, the substrate layer is thicker than the stress luminescent layer, and therefore, the responsiveness of the stress luminescent layer to stress can be enhanced.

### (Item 2)

A test sheet according to another aspect of the present disclosure is a test sheet configured to be adhered to a target object to which a load is applied in measuring stress or strain, the test sheet comprising:
an antistatic layer;
a substrate layer formed on the antistatic layer, the substrate layer containing a polymeric material; and
a stress luminescent layer formed on the substrate layer, the stress luminescent layer containing a stress luminescent material.

According to the test sheet as recited in the above-described Item 2, the response of the luminescence to stress of the stress luminescent layer can be enhanced by the fact that the antistatic layer is positioned between the substrate layer and the target object.

### (Item 3)

A test sheet according to one aspect of the present disclosure is a test sheet configured to be adhered to a target object to which a load is applied in measuring stress or strain, the test sheet comprising:
an adhesive layer for adhering the test sheet to the target object;
a substrate layer formed on the antistatic layer, the substrate layer containing a polymeric material; and
a stress luminescent layer formed on the substrate layer, the stress luminescent layer containing a stress luminescent material.

According to the test sheet as recited in the above-described Item 3, it becomes no longer necessary to separately prepare an adhesive when adhering the test sheet to a target object.

### (Item 4)

The test sheet as recited in the above-described Item 3 may further be provided with an antistatic layer formed between the adhesive layer and the substrate layer.

According to the test sheet as recited in the above-described Item 4, the response of the luminescence to stress of the stress luminescent layer can be enhanced by the fact that the antistatic layer is positioned between the substrate layer and the target object.

### (Item 5)

In the test sheet as recited in the above-described Item 3 or 4, the adhesive layer may be made of a removable adhesive.

According to the test sheet as recited in the above-described Item 5, the test sheet can be removed from the target object without leaving any residues.

### (Item 6)

In the test sheet as recited in any one of the above-described Items 1 to 5, the stress luminescent layer may have a thickness of 10 μm or less.

According to the test sheet as recited in the above-described Item 6, the luminescence of the stress luminescent layer more reliably reflects the stress or the strain of the target object.

### (Item 7)

A measurement method according to another one of the present disclosure is a method of measuring stress or strain of a target object, the method comprising:
a step of irradiating one or more test sheets adhered to the target object with excitation light, each of the one or more test sheets comprising a substrate layer containing a polymeric material, and a stress luminescent layer formed on the substrate layer, the stress luminescent layer containing a stress luminescent material;
a step of acquiring an image of each of the one or more test sheets irradiated with the excitation light; and
a step of identifying luminous intensity for the one or more test sheets from each of the captured images of the one or more test sheets.

According to the measurement method as recited in the above-described Item 7, a test sheet having a stress luminescent layer with enhanced responsiveness of the luminescence to stress is utilized, whereby the stress in the target object can be measured more accurately.

### (Item 8)

In the measurement method as recited in the above-described Item 7, the substrate layer may be thicker than the stress luminescent layer.

According to the measurement method as recited in the above-described Item 8, the substrate layer is thicker than the stress luminescent layer, and therefore, the responsiveness of the stress luminescent layer to stress can be enhanced.

### (Item 9)

In the measurement method as recited in the above-described Item 7 or 8, each of the one more test sheets further comprises an antistatic layer disposed on an opposite side of the substrate layer opposite to a side on which the stress luminescent layer is formed.

According to the test sheet as recited in the above-described Item 9, the response of the luminescence to stress of the stress luminescent layer can be enhanced by the fact that the antistatic layer is positioned between the substrate layer and the target object.

### (Item 10)

In the measurement method as recited in the above-described Items 7 to 9, each of the one or more test sheets further comprises an adhesive layer disposed on an opposite side of the substrate layer opposite to a side on which the stress luminescent layer is formed.

According to the test sheet as recited in the above-described Item 10, it is no longer necessary to separately prepare an adhesive when adhering the test sheet to a target object.

### (Item 11)

In the measurement method as recited in the above-described Item 10, the adhesive layer may be made of a removable adhesive.

According to the measurement method as recited in the above-described Item 11, the test sheet can be removed from the target object without leaving any residues.

### (Item 12)

In the measurement method as recited in any one of the above-described Items 7 to 11, the stress luminescent layer may have a thickness of 10 μm or less.

According to the measurement method as recited in the above-described Item 12, the luminescence of the stress luminescent layer more reliably reflects the stress or the strain of the target object.

### (Item 13)

In the measurement method as recited in any one of the above-described Items 7 to 12, the one or more test sheets may include a plurality of test sheets cut out from the same sheet, and the plurality of test sheets may be adhered to each of a plurality of locations on the target object.

According to the measurement method described in the above-described Item 13, the stresses or the strains at a plurality of locations on a target object can be measured utilizing a plurality of test sheets having uniform optical properties by being cut out from the same sheet.

Note that the embodiments disclosed here should be considered illustrative and not restrictive in all respects. It should be noted that the scope of the embodiments is indicated by claims and is intended to include all modifications within the meaning and scope of the claims and equivalents. Further, it is intended that each of the techniques in the embodiments may be implemented alone or, if necessary, in combination with other techniques in the embodiments if possible.

### DESCRIPTION OF REFERENCE SYMBOLS

1, 1A: Sample
1 X: Hole
1c: First end portion
1d: Second end portion
40: Holder
41: Movable wall
42: Fixed wall
43, 44: Connection member
46: Actuator
50: Light source
60: Camera
90, 90X, 90Y, 90Z: Test sheet
90A: Sheet
91: Stress luminescent layer
92: Substrate layer
93: Antistatic layer
94: Adhesive layer
100: Measuring device

1. A test sheet configured to be adhered to a target object to which a load is applied in measuring stress or strain, the test sheet comprising:
a substrate layer containing a polymeric material; and
a stress luminescent layer formed on the substrate layer, the stress luminescent layer containing a stress luminescent material,
wherein the substrate layer is thicker than the stress luminescent layer.

2. A test sheet configured to be adhered to a target object to which a load is applied in measuring stress or strain, the test sheet comprising:
an antistatic layer;
a substrate layer formed on the antistatic layer, the substrate layer containing a polymeric material; and
a stress luminescent layer formed on the substrate layer, the stress luminescent layer containing a stress luminescent material.

3. A test sheet configured to be adhered to a target object to which a load is applied in measuring stress or strain, the test sheet comprising:
an adhesive layer for adhering the test sheet to the target object;
a substrate layer formed on the antistatic layer, the substrate layer containing a polymeric material; and
a stress luminescent layer formed on the substrate layer, the stress luminescent layer containing a stress luminescent material.

4. The test sheet as recited in claim 3, further comprising:
an antistatic layer formed between the adhesive layer and the substrate layer.

5. The test sheet as recited in claim 3 or 4,
wherein the adhesive layer is made of a removable adhesive.

6. The test sheet as recited in any one of claims 1 to 5,
wherein the stress luminescent layer has a thickness of 10 μm or less.

7. A method of measuring stress or strain of a target object, the method comprising:
a step of irradiating one or more test sheets adhered to the target object with excitation light, each of the one or more test sheets comprising a substrate layer containing a polymeric material, and a stress luminescent layer formed on the substrate layer, the stress luminescent layer containing a stress luminescent material;
a step of acquiring a captured image of each of the one or more test sheets irradiated with the excitation light; and
a step of identifying luminous intensity for the one or more test sheets from each of the captured images of the one or more test sheets.

8. The measurement method as recited in claim 7,
wherein the substrate layer is thicker than the stress luminescent layer.

9. The measurement method as recited in claim 7 or 8,
wherein each of the one more test sheets further comprises an antistatic layer disposed on an opposite side of the substrate layer opposite to a side on which the stress luminescent layer is formed.

10. The measurement method as recited in any one of claims 7 to 9,
wherein each of the one or more test sheets further comprises an adhesive layer disposed on an opposite side of the substrate layer opposite to a side on which the stress luminescent layer is formed.

11. The measurement method as recited in claim 10,
wherein the adhesive layer is made of a removable adhesive.

12. The measurement method as recited in any one of claims 7 to 11,
wherein the stress luminescent layer has a thickness of 10 μm or less.

13. The measurement method as recited in any one of claims 7 to 12,
wherein the one or more test sheets include a plurality of test sheets cut out from the same sheet, and
wherein the plurality of test sheets is adhered to a respective plurality of locations on the target object.
